(19) United States
(12) Patent Application Publication
(10) Pub. No.: US 2013/0252097 A1
(43) Pub. Date: Sep. 26, 2013

(54) METHOD TO PREPARE SILICON PARTICLES FOR USE IN LITHIUM SECONDARY BATTERY ANODES

(71) Applicant: ELECTROCHEMICAL MATERIALS, BATON ROUGE, LA (US)

(72) Inventors: WANLI XU, BATON ROUGE, LA (US); JOHN T. FUSSELL, BATON ROUGE, LA (US)

(73) Assignee: ELECTROCHEMICAL MATERIALS, BATON ROUGE, LA (US)

(21) Appl. No.: 13/874,530

(22) Filed: Jun. 11, 2013

(51) Int. Cl. H01M 4/36; H01M 4/62; H01M 4/04; H01M 4/38

(52) U.S. Cl. CPC H01M 4/364; H01M 4/386; H01M 4/622; H01M 4/0404
USPC 429/213; 429/231.8; 429/217; 427/58; 427/122

(57) ABSTRACT

The disclosure describes a process to fabricate composite anodes for lithium secondary batteries using silicon particles obtained from the byproducts of silicon manufacturing processes. Silicon particles are obtained from the byproducts of solar cell manufacturing or silicon wafer manufacturing steps such as sawing, polishing and deposition processes. Said silicon particles are mechanically resized, mixed with carbonaceous materials and formed into an anode for a lithium secondary battery.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Field of Invention

The present invention generally relates to methods for fabricating silicon-containing anodes using silicon particles recovered as byproducts from single crystal or poly-crystalline silicon manufacturing. More particularly, the present invention relates to methods for integrating recycled silicon particles in high-capacity anodes for lithium ion batteries.

2. Description of the Related Art

Rechargeable lithium batteries are commonly used in portable electronic devices such as cell phones, tablet computers, and laptop computers and are also used in electric vehicles. Conventional batteries are made using spinel cathodes and graphite anodes and battery capacities are limited to approximately 100 mAh·g⁻¹. There is considerable interest in new electrode materials that would increase the capacity of lithium ion batteries.

Silicon has become a promising candidate to replace graphite as an anode material for rechargeable lithium ion batteries. Silicon has a theoretical capacity for lithium storage of 4200 mAh·g⁻¹, which is over ten times higher than that of a conventional graphite material. Despite the extremely high specific capacity, silicon as an anode material shows high volumetric expansion for over 300% when fully charged with lithium. The volumetric expansion will result in cracking and pulverization of silicon so as to poor cycle performance for bulky silicon anodes. Recent researches on nano-structured silicon (including silicon nanoparticles, nanowires, nanotubes, complex 3-D structures, and etc.) have demonstrated great potential in achieving both high capacity and extensive cycle life for silicon anodes in lithium batteries. An important concern centers on the composition, size and shape of silicon that could be used to produce a high-capacity silicon anode.

There are many methods to create silicon anodes using various sources of silicon. Silicon anodes may be made using solely silicon as the active material or silicon may be combined with other active materials such as graphite to form composite anodes. Silicon-only anode materials such as nanowires, nanofilms, or other nanostructures are typically created by vapor deposition process such as chemical vapor deposition (CVD) using silane precursors such as SiH.sub.4. Silicon in composite anodes typically originates from growth methods such as CVD, or solution growth, or from subtractive methods such as laser ablation, etching, or mechanical attrition. In general, the aforementioned methods of producing silicon are expensive and the resulting materials may not be ideally suited for use in anodes due to their size, shape, purity or composition, and surface chemistry. For example, nano-silicon produced via CVD usually shows high purity and controllable morphology; however, high cost, low yield, and toxic precursors prevent CVD process from commercialization. Silicon nanowires generated via patterned etching involves costly photolithography and electrochemical etching in hydrofluoric acid. Metal-assisted electroless etching in hydrofluoric acid to produce silicon nanowires is scalable and capable of mass fabrication; however, diameter of silicon nanowires is not facilely controllable in this electroless etching process.

Currently, about 80% of the initial metallurgical-grade silicon material is wasted during the process of making silicon solar cells or wafers. After a silicon ingot is grown, it is sliced into wafers. Sawing with multiple wiresaws is now the preferred method used to slice silicon ingots. Wiresaw technology can produce wafers as thin as 200 micrometer; however, a layer of silicon about 250-280 micrometers thick is typically lost per wafer. Depending on wafer thickness, kerf loss represents from 25% to 50% of the silicon ingot material. Likewise, waste particles are generated when the wafers are lapped or polished to their final thickness. Lapping and polishing operations remove an additional 5 to 30% of the final product wafer. The waste is difficult to recycle due to the presence of solvents, oils, other impurities such as silicon carbides, and the native oxide at the surface of waste silicon particles.

Silicon byproducts from sources such as kerf are difficult to use directly as lithium-ion batteries since key parameters such as silicon particle size, surface oxides, and impurities, do not fulfill the requirements for silicon anode materials.

As described in U.S. Pat. No. 8,034,313 and U.S. Pat. No. 8,231,006, it is possible to recover silicon from byproducts, such as kerf or silicon slurry generated from semiconductor manufacturing process. In this process, silicon particles are separated from kerf or slurry by sedimentation centrifugation, filtration centrifugation, and hydro-cyclone separation. The waste silicon may be processed to recover the raw material used in solar crystals.

U.S. Pat. No. 6,780,665 describes methods of centrifuging, decanting, filtration, froth flotation and high energy electrical discharge techniques to recover crystalline silicon metal kerf from wire saw slurries for use in thin-layer photovoltaic cell configurations.

However, these processes only focus on purifying and recovering crystalline silicon from kerf or silicon slurry for photovoltaic cell purpose. No methods on silicon particle size restriction as well as separation and purification for battery purposes have been reported.

Thus, there exists great value in recovering silicon from silicon manufacturing processes and the recovered silicon particles can be used as battery anode material. A method to recycle the byproducts such as kerf or polishing waste to create anodes for lithium ion batteries would be extremely desirable.

### SUMMARY OF THE INVENTION

In one embodiment of the present invention, a process is described to fabricate a silicon particle anode by recovering crystalline silicon metal kerf from wiresaw slurries.

In another embodiment of the present invention, a process is described to fabricate a silicon particle anode by recovering crystalline silicon from lapping/polishing of silicon wafers.

In yet another embodiment of the present invention, a process is described to fabricate a silicon particle anode by recovering fines from a fluidized bed reactor.

In yet another embodiment of the present invention, a process is described comprising wiresaw slurry grinding and silicon particle recovery.

In yet another embodiment of the present invention, a composite anode is described consisting said silicon particles recovered from the process.

### BRIEF DESCRIPTION OF THE DRAWING

FIG. 1 is an SEM image of silicon particles before resizing.

FIG. 2 is an SEM image of silicon particles after resizing and separation using solvent evaporation.

FIG. 3 is the charge/discharge performance of a lithium-ion cell containing a silicon composite anode, which was made with ball-milled silicon particles.

### DETAILED DESCRIPTION OF THE INVENTION

The present invention is believed to be applicable to a variety of different types of lithium rechargeable batteries and devices and arrangements involving silicon composite electrodes. While the present invention is not necessarily limited, various aspects of the invention may be appreciated through a discussion of examples using the context.

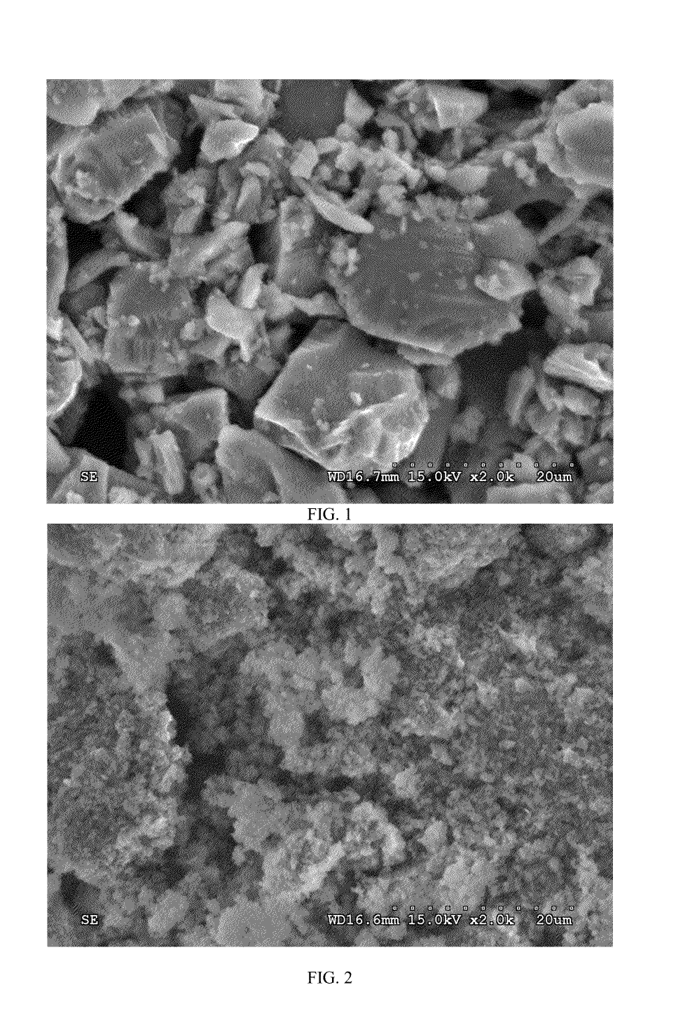

In one embodiment of the present invention, a process to fabricate silicon particles for use in an anode by recovering crystalline silicon kerf from wiresaw slurries comprises milling and recovering smaller particles. Said wiresaw slurry is the by-product of wiresaw operations of crystalline silicon ingots and wafers, the by-product is comprised of crystalline silicon particles, silicon carbide particles, organic solvents such as glycols, and other impurities. As shown in FIG. 1, particles sizes are in the scale of micrometers. Said particles can be mixed with carrier liquid to create a slurry, wherein the solvent can be water, methanol, ethanol, or other organic solvent. Said slurry may be milled in a ball mill to decrease the average particle size. Said particles can also be directed milled in a ball mill to decrease the average particle size.

In another embodiment of the present invention, a process to fabricate silicon particles for use in an anode by recovering crystalline silicon particles from lapping/polishing slurries comprises milling and recovering smaller particles. Said lapping/polishing slurry is the by-product of lapping/polishing operations of crystalline silicon wafers, the byproduct is comprised of crystalline silicon particles, silicon carbide particles, organic solvents such as glycols, and other impurities. Said particles can be mixed with carrier liquid to create a slurry, wherein the carrier liquid can be water, methanol, ethanol, or other organic solvent. Said slurry may be milled in a ball mill to decrease the average particle size. Said particles can also be directed milled in a ball mill to decrease the average particle size.

In yet another embodiment of the present invention, a process to fabricate silicon particles for use in an anode by recovering crystalline silicon particles from vapor deposition reactors comprises milling and recovering smaller particles. Said silicon particles are the by-product of silicon films deposited on the internal portions of a vapor deposition reactor, the by-product is comprised of poly-crystalline silicon and other impurities. Said particles can be mixed with carrier liquid to create a slurry, wherein the carrier liquid can be water, methanol, ethanol, or other organic solvent. Said slurry may be milled in a ball mill to decrease the average particle size. Said particles can also be directed milled in a ball mill to decrease the average particle size.

The average particle diameter may be decreased by milling the particles with milling media. Examples of the milling media may be, but are not limited to, alumina, silica, chrome, tungsten, stainless steel balls, as well as other ceramic and metal milling medias, wherein the effective diameter of the milling media used in the ball mill ranges from 1 millimeter to 20 millimeters, with a preferred diameter of 4 to 6 millimeters. The volumetric ratio of stainless steel balls used in the ball mill to the milling material ranges from 10:1 to 1:1, with a preferred ratio of 4:1. The milling process can be carried out in a batch or continuous process with recycling.

Milled silicon particles with small average diameters less than 500 nanometers, are separated and recovered from the slurry. In one embodiment, an aerosol is created using the slurry and the aerosol is evaporated and filtered. Dense and large particles are excluded in the aerosol formation and may be filtered to further restrict their size. Small silicon particles are recovered from the filters or from the residue remaining after aerosol evaporation. Said silicon particles obtained from abovementioned process have a diameter less than 500 nanometers, preferably less than 300 nanometers (FIG. 2).

In one embodiment, the slurry is fed into a bowl centrifuge for separation. The bowl and lagging scroll rotate at a high speed in the same direction. The slurry is conveyed through the centrifuge feed pipe and inlet ports in the scroll body into the bowl and accelerated to the bowl speed. Centrifugal force causes the solids, which are heavier than the carrier liquid, to settle against the bowl wall. The scroll conveys the deposited layer of heavy solids toward the conical bowl section, over the drying zone and ejects them through ports into the stationary solids housing and down the discharge chute. The solids that are lighter than the carrier liquid float and are conveyed with the liquid toward the cylindrical end of the bowl. When the floating particles have reached the second inner cone, scroll flights wound in the opposite direction to those conveying sedimentary solids transfer the lighter solids across a drying zone to the exit ports. The liquid is skimmed off and discharged under pressure by an impeller at the cylindrical end of the bowl. The liquid may be recycled as carrier liquid.

In one embodiment, said silicon particles may be cleaned or chemically treated to remove impurities or surfaces oxides. Cleaning agents such surfactants, complexing agents, acids, oxidizing agents, or bases may be used to remove unwanted impurities from silicon nanoparticle surfaces. Chemical treatments such as dilute hydrofluoric acid may be used to remove the native oxide present at silicon nanoparticle surfaces.

In yet another embodiment of the present invention, a composite anode may be comprised of the recycled silicon particles, carbonaceous materials, polymer binders and a current collector. The carbonaceous materials may be obtained from various sources, examples of which may include, but not limited to, petroleum pitches, coal tar pitches, petroleum cokes, flake coke, natural graphite, synthetic graphite, soft carbons, as well as other carbonaceous material that are known in the manufacture of prior art electrodes, although these sources are not elucidated here. The binder may be, but is not limited to, polyvinylidene fluoride, polyacrylic acid, polyamide imide, sodium carboxymethyl cellulose, styrene-butadiene rubber, or similar. The mix comprising the anode active material, carbonaceous materials, and the binder can be applied to a current collector. The current collector can be a metallic copper film with a preferred thickness of 10 micrometers to 100 micrometers. In this fashion, the arrangement can be used as an anode in a lithium rechargeable battery.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

### EXAMPLES

While embodiments have been generally described, the following examples demonstrate particular embodiments in practice and advantage thereof. The examples are given by way of illustration only and are not intended to limit the specification or the claims in any manner. The following illustrates exemplary details as well as characteristics of such surface modified silicon particles as the active anode materials for lithium ion batteries.

In this example, 100 grams of silicon slurry (approximately 50 vol. % diameter larger than 2 micrometers and approximately 50 vol. % diameter ranging from 0.5 micrometer to 100 nanometers) were mixed with 100 milliliters of anhydrous methanol as co-solvent in a 2-liter ceramic ball mill container with 75 grams of stainless balls (average diameter 4 millimeters). The resulting mixture was milled for 8 hours at 25 degrees Celsius.

The resulting slurry was heated under an inert atmosphere to evaporate the co-solvent. Light silicon particles were carried away from the slurry in the form of an aerosol, leaving heavy silicon carbide, silicon, polyglycol solvent and other impurities in the slurry. The silicon particles are captured by condensation of the aerosol vapor in a buffer container. Said silicon particles obtained from the abovementioned process have a diameter less than 500 nanometers. Approximately 10 grams of silicon particles can be obtained from the process described above.

Approximately 0.5 grams of the recovered silicon particles were cleaned via 10 milliliters of 1% hydrofluoric acid aqueous solution, followed by rinsing with 10 milliliters of de-ionized water for three times. The silicon particles were heated at 75 degrees Celsius under argon atmosphere until completely dry.

The cleaned particles were well mixed with 0.5 grams of carbon black (average particle size below 50 nanometer), 3.5 grams of natural graphite (average particle size below 40 micrometer), and 10 milliliters 5 wt. % polyvinylidene fluoride in n-methylpyrrolidone solution (equivalent to 0.5 grams of polyvinylidene fluoride). The resulting mixture was applied to a copper foil (˜25 micrometer in thickness) via doctor blade method to deposit a layer of approximately 100 micrometers. The film was then dried in vacuum at 120 degrees Celsius for 24 hours.

The resulting anode was assembled and evaluated in a lithium secondary coin cell CR2032 with lithium cobalt oxide as the other electrode. A disk of 1.86 cm² was punched from the film as the anode. The anode active material weight is approximately 5 micrograms. The other electrode was a lithium cobalt oxide cathode with a thickness of 100 micrometers and had the same surface area as the anode. A microporous trilayer polymer membrane was used as separator between the two electrodes. Approximately 1 milliliter 1 molar LiPF.sub.6 in a solvent mix comprising ethylene carbonate and dimethyl carbonate with 1:1 volume ratio was used as the electrolyte in the lithium cell. All of the above experiments were carried out in glove box system under an argon atmosphere with less then 1 part per million water and oxygen.

The assembled lithium coin cell was removed from the glove box and stored in ambient conditions for another 24 hours prior to testing. The coin cell was charged and discharged at a constant current of 0.5 mA, and the charge and discharge rate is approximately C/5 from 2.75 V to 4.2 V versus lithium for over 100 cycles.

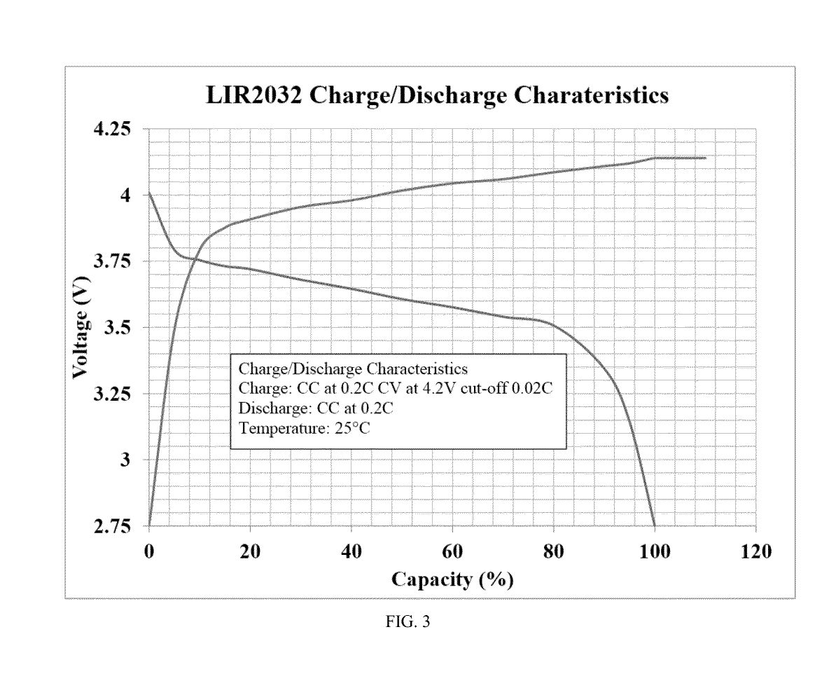

FIG. 3 shows the charge and discharge capacities over cell potential of the sample coin cell after 100 charge and discharge cycles. Reversible capacity of over 160 mAh·g⁻¹ can be maintained after over 100 cycles with above 80% depth of discharge.

The preferred embodiment of the present invention has been disclosed and illustrated. The invention, however, is intended to be as broad as defined in the claims below. Those skilled in the art maybe able to study the preferred embodiments and identify other ways to practice the invention those are not exactly as described herein. It is the intent of the inventors that variations and equivalents of the invention are with in the scope of the claims below and the description, abstract and drawings are not to be used to limit the scope of the invention.

We claim:

1. An electrode material for a lithium ion battery containing silicon particles wherein the electrode material is prepared by:
a. recovering the silicon particles as a byproduct from the manufacture of single crystalline or polycrystalline silicon products;
b. restricting a size of the silicon particles to a range of 10 nm and 10 μm;
c. forming the silicon particles with the restricted size into a composite matrix with carbonaceous materials and a binder; and
d. attaching the composite matrix to a current collector.

2. An electrode material according to claim 1 wherein the silicon particles are the by-product of wiresaw operations of crystalline silicon ingots and wafers.

3. An electrode material according to claim 1 wherein the silicon particles result from saw kerf from slicing wafers from a silicon ingot.

4. An electrode material according to claim 1 wherein the silicon particles are the by-product of lapping, grinding, or polishing of crystalline silicon ingots and wafers.

5. An electrode material according to claim 1 wherein the silicon particles are the by-product of a vapor deposition reactor.

6. An electrode material according to claim 1 wherein the silicon particles are resized via mechanical milling.

7. An electrode material according to claim 1 wherein a solvent is used to aid in resizing the silicon particles.

8. An electrode material according to claim 1 wherein the resizing of the silicon particles is carried out in a ball mill.

9. An electrode material according to claim 1 wherein the silicon particles are recovered with a preferred diameter ranging from 50 nm to 500 nm.

10. An electrode material according to claim 1 wherein the silicon particles are separated from metallic or organic impurities prior to assembly in the battery.

11. An electrode material according to claim 1 wherein a native oxide of the silicon particles is removed prior to forming into the composite matrix.

12. An electrode material according to claim 1, wherein a weight percent of the silicon particles ranges from 0.5% to 50% based on the weight of the composite matrix.

13. An electrode material according to claim 1, wherein the silicon particles include silicon carbide.

14. An electrode material according to claim 1, wherein the silicon particles include boron, phosphorous, arsenic, antimony dopants, and combinations thereof.

15. An electrode material according to claim 1, wherein the carbonaceous materials are graphite, carbon black, pitch or acetylene black.

16. An electrode material according to claim 1, wherein the polymer binder is polyvinylidene fluoride, polyacrylic acid, polyamide imide, sodium carboxymethyl cellulose or styrene-butadiene rubber.

17. An electrode material according to claim 1, wherein the weight percent of the silicon particles ranges from 5% to 40% based on the weight of the composite matrix.

18. An electrode material according to claim 1, wherein the weight percent of the silicon particles ranges from 15% to 30% based on the weight of the composite matrix.
